(19) United States
(12) Patent Application Publication
(10) Pub. No.: US 2018/0009097 A1
(43) Pub. Date: Jan. 11, 2018

(54) POWERED FASTENER DRIVER

(71) Applicant: TTI (MACAO COMMERCIAL OFFSHORE) LIMITED, Macau (MO)

(72) Inventors: Reid Cheatham, Greenville, SC (US); Matthew Conner, Greenville, SC (US)

(21) Appl. No.: 15/641,459

(22) Filed: Jul. 5, 2017

Related U.S. Application Data
(60) Provisional application No. 62/358,944, filed on Jul. 6, 2016.

(51) Int. Cl. B25C 1/00; B25C 1/04

(52) U.S. Cl. CPC B25C 1/008; B25C 1/047

(57) ABSTRACT

A powered fastener driver includes a magazine containing fasteners therein, a drive blade movable in a reciprocating manner to discharge a fastener from the magazine for each drive cycle of the drive blade, a first trigger operable to initiate a drive cycle of the drive blade, and a second trigger movable between a first position, in which the first trigger is inhibited from moving to initiate the drive cycle, and a second position, in which the first trigger is movable to initiate the drive cycle.

### CROSS-REFERENCE TO RELATED APPLICATIONS

This application claims priority to co-pending U.S. Provisional Patent Application No. 62/358,944 filed Jul. 6, 2016, the entire content of which is incorporated by reference.

### FIELD OF THE INVENTION

The present invention relates to a power tool, and more particularly to a powered fastener driver.

### BACKGROUND OF THE INVENTION

There are various fastener drivers used to drive fasteners (e.g., nails, tacks, staples, etc.) into a workpiece known in the art. These fastener drivers operate utilizing various means (e.g., compressed air generated by an air compressor, electrical energy, flywheel mechanisms) known in the art, but often these designs are met with power, size, and cost constraints.

### SUMMARY OF THE INVENTION

The invention provides, in one aspect, a powered fastener driver including a magazine containing fasteners therein, a drive blade movable in a reciprocating manner to discharge a fastener from the magazine for each drive cycle of the drive blade, a first trigger operable to initiate a drive cycle of the drive blade, and a second trigger movable between a first position, in which the first trigger is inhibited from moving to initiate the drive cycle, and a second position, in which the first trigger is movable to initiate the drive cycle.

The invention provides, in another aspect, a method of operating a powered fastener driver. The method includes providing a first trigger operable to initiate a drive cycle of a drive blade of the fastener driver, actuating a second trigger from a first position to a second position, and then actuating the first trigger to initiate the drive cycle of the drive blade.

Other features and aspects of the invention will become apparent by consideration of the following detailed description and accompanying drawings.

### BRIEF DESCRIPTION OF THE DRAWINGS

FIG. 1 is a side view of a powered fastener driver in accordance with an embodiment of the invention.

FIG. 2 is an enlarged perspective view of a portion of the powered fastener driver of FIG. 1.

FIG. 3 is a side view of the powered fastener driver of FIG. 1, illustrating a linkage extending between an activation trigger and a safety trigger of the fastener driver, with the safety trigger in a locked position.

FIG. 4 is a side view of the powered fastener driver of FIG. 1, illustrating the safety trigger in a released position.

FIG. 5 is a side view of the powered fastener driver of FIG. 1, illustrating movement of the linkage in response to actuation of the activation trigger, with the safetry trigger in the released position.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

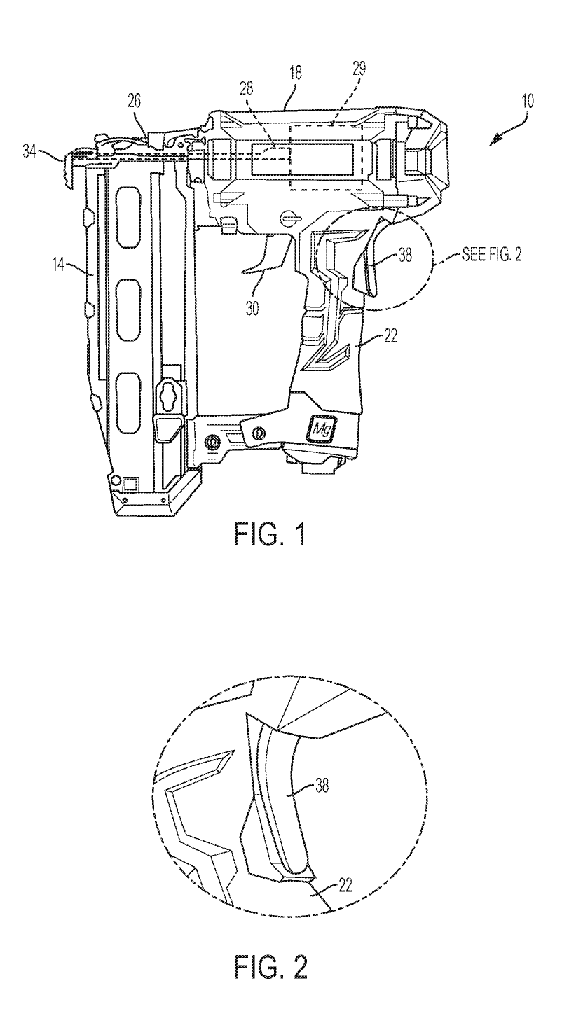

With reference to FIG. 1, a fastener driver 10 is operable to drive fasteners (e.g., nails, tacks, staples, etc.) held within a magazine 14 into a workpiece. The fastener driver 10 includes a housing 18 with a handle portion 22, a nosepiece 26 extending from the housing 18 from which the fasteners are ejected, and a drive blade 28 movable in a reciprocating manner within the nosepiece 26 for discharging the fasteners from the magazine 14. The fastener driver 10 also includes a drive mechanism 29 disposed within the housing 18 for reciprocating the drive blade 28 through consecutive drive cycles, for each one of which a single fastener is discharged from the magazine 14 at the nosepiece 26 and driven into a workpiece. In some embodiments, the drive mechanism 29 includes an on-board air compressor that generates pressurized air for applying a force on the drive blade 28. In other embodiments, the drive mechanism 29 may include a compression spring or a gas spring for applying a force on the drive blade 28. In yet other embodiments, the drive mechanism 29 may include a remote power source (e.g., an external source of pressurized air) for applying a force on the drive blade 28.

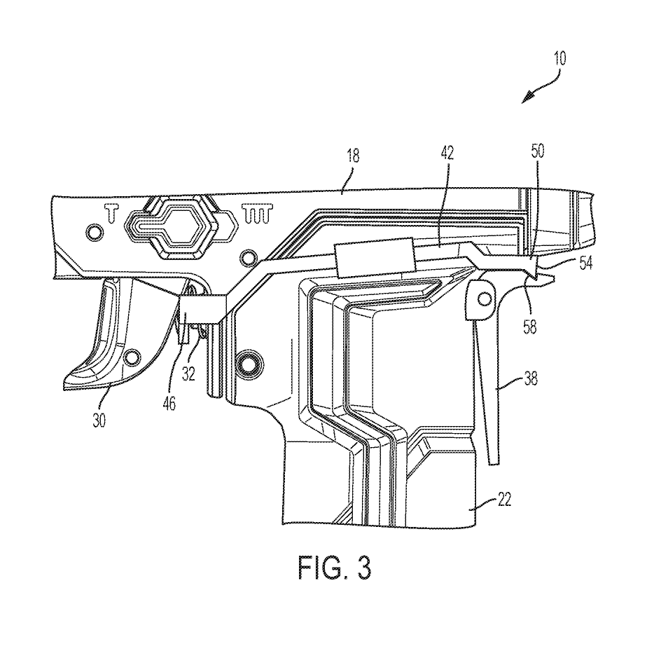

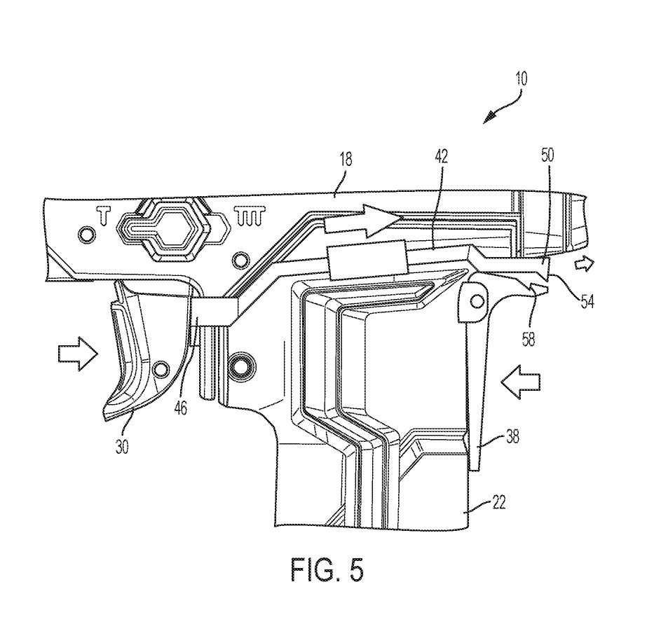

The fastener driver 10 further includes a first or activation trigger 30 disposed adjacent the handle portion 22 that is user-actuated to begin each drive cycle and a contact arm 34 slidable relative to the nosepiece 26 in response to contacting a workpiece. Specifically, trigger 30 is movable from a default position (FIG. 3) to a depressed position (FIG. 5) to initiate the drive cycle. The activation trigger 30 is biased toward the default position by a biasing element, such as a spring 32 (FIG. 3). Also, the contact arm 34 is movable between a biased, extended position in which fasteners are inhibited from being discharged from the magazine 14, and a retracted position in which fasteners are permitted to be discharged from the magazine 14. In some embodiments, the contact arm 34 mechanically interfaces with the activation trigger 30 to selectively permit a drive cycle to be initiated. In other embodiments, the contact arm 34 may electrically interface with a master controller which, in turn, is electrically connected with the activation trigger 30 to selectively permit a drive cycle to be initiated. In such an embodiment, the master controller is operable to accept a trigger input from the activation trigger 30 and a contact arm input from the contact arm 34. Both the trigger input and the contact arm input may be provided by sensors, switches, or other electrical and/or electromechanical components. Upon detecting both the contact arm input and the trigger input, the master controller may initiate a drive cycle.

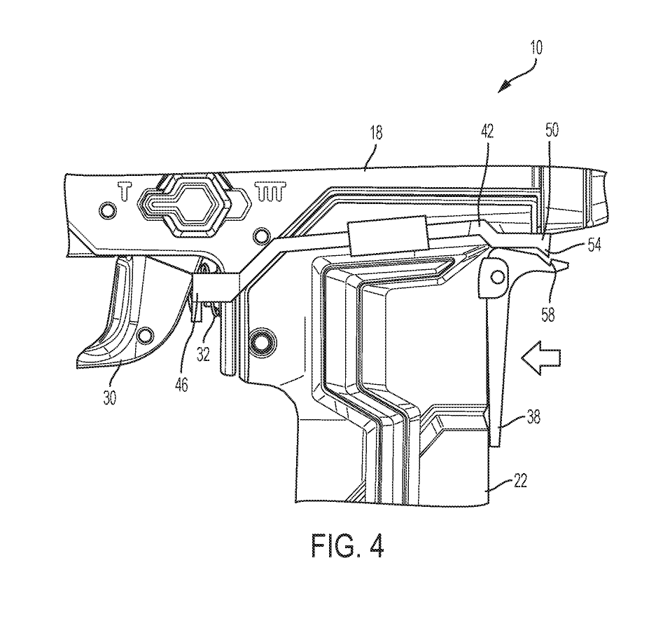

With reference to FIGS. 1 and 2, the fastener driver 10 further includes a second or safety trigger 38 disposed adjacent the handle portion 22 on an opposite side as the activation trigger 30. While the activation trigger 30 is actuated toward the depressed position by the user's fingers, the safety trigger 38 is actuated toward a depressed position (FIG. 4) by the web of the user's hand (e.g., the interdigital skin fold between the thumb and the forefinger) as the user grasps the handle portion 22. In other words, in the illustrated embodiment of the fastener driver 10, the activation trigger 30 is disposed on the front of the handle portion 22, while the safety trigger 38 is disposed on the rear of the handle portion 22 (from the frame of reference of FIG. 1). The fastener driver 10 also includes a biasing element (e.g., a spring, not shown) for biasing the safety trigger 38 toward a default locked position as shown in FIG. 3.

With reference to FIGS. 3-5, the fastener driver 10 also includes a linkage 42 supported by the housing 18 and extending between the activation trigger 30 and the safety trigger 38. Although the linkage 42 is schematically illustrated as being positioned on the exterior of the housing 18 in FIGS. 3-5, the linkage 42 is positioned internally of the housing 18 as shown in FIG. 1. The linkage 42 inhibits movement of (i.e., “locks out”) the activation trigger 30 when the safety trigger 38 is in the locked position (FIG. 3). However, when the safety trigger 38 is moved to the released position, it no longer interferes with the linkage 42 (FIG. 4), permitting the activation trigger 30 to be depressed (FIG. 5).

The linkage 42 includes a first end 46 adjacent the activation trigger 30 and an opposite, second end 50 adjacent the safety trigger 38. The first end 46 is maintained in sliding contact with activation trigger 30 by the spring 32, whereas the second end 50 includes a protrusion 54 that is selectively receivable in a corresponding recess 58 of the safety trigger 38. Specifically, the protrusion 54 is received within the recess 58 when the safety trigger 38 is in the locked position (FIG. 3), which causes the linkage 42 to interfere with actuation of the activation trigger 30. When the protrusion 54 is removed from the recess 58 in response to the safety trigger 38 being pivoted from the locked position (FIG. 3) to the released position (FIG. 4), the linkage 42 is moveable relative to the safety trigger 38 in response to actuation of the activation trigger 30. Although not shown in FIGS. 3-5, the linkage 42 is supported within the housing 18 for translation relative to the housing 18. Accordingly, the second end 50 of the linkage 42 is slidable relative to the safety trigger 38 when the safety trigger 38 is in the released position. In the illustrated embodiment, the linkage 42 is movable in unison with and in response to pivoting movement of the activation trigger 30. In other embodiments, instead of a mechanical linkage 42, the fastener driver 10 may include an electronic linkage between the safety trigger 38 and the activation trigger 30 for selectively permitting actuation of the activation trigger 30. In such an embodiment, both of the triggers 30, 38 would be configured as electrical switches connected with a controller onboard the fastener driver 10, with the safety trigger 38 providing an input signal to the controller upon being depressed by the user to thereby permit initiation of a drive cycle in response to the user depressing the activation trigger 30. Without first receiving the input signal from the safety trigger 38, the controller will not enable the activation trigger 30.

In one manner of operation of the fastener driver 10 (known as single sequential mode), while concurrently pressing the safety trigger 38 and grasping the handle portion 22 with the same hand, an operator first presses the contact arm 34 against a workpiece, causing it to retract, and then presses the activation trigger 30 to initiate a drive cycle for discharging a fastener from the magazine 14. Upon pressing the safety trigger 38, the protrusion 54 is removed from the recess 58, releasing the lockout of the activation trigger 30. Thereafter, the linkage 42 is movable in unison with pivoting movement of the activation trigger 30 in response to the operator depressing the activation trigger 30. The linkage 42 moves concurrently each time the activation trigger 30 is pressed, such that the protrusion 54 moves relative to the recess 58 of the safety trigger 38. If the safety trigger 38 is not first pressed, the protrusion 54 interferes with the safety trigger 38 and the linkage 42 will lockout the activation trigger 30, preventing it from being pressed.

In another manner of operation of the fastener driver 10 (known as bump-fire mode), an operator first actuates the safety trigger 38 from the locked position to the released position, thereby releasing the lockout of the activation trigger 30. Thereafter, a drive cycle is initiated each time the contact arm 34 is retracted coinciding with being depressed against a workpiece.

Various features of the invention are set forth in the following claims.

What is claimed is:

1. A powered fastener driver comprising:
a magazine containing fasteners therein;
a drive blade movable in a reciprocating manner to discharge a fastener from the magazine for each drive cycle of the drive blade;
a first trigger operable to initiate a drive cycle of the drive blade; and
a second trigger movable between a first position, in which the first trigger is inhibited from moving to initiate the drive cycle, and a second position, in which the first trigger is movable to initiate the drive cycle.

2. The powered fastener driver of claim 1, further comprising a linkage extending between the first and second triggers, wherein the linkage is responsive to movement of the first trigger to initiate the drive cycle when the second trigger is in the second position.

3. The powered fastener driver of claim 2, wherein the linkage includes a first end adjacent the first trigger and an opposite, second end adjacent the second trigger.

4. The powered fastener driver of claim 3, wherein the second end of the linkage includes a protrusion engageable with the second trigger when the second trigger is in the first position.

5. The powered fastener driver of claim 4, wherein the second trigger includes a recess that receives the protrusion when the second trigger is in the first position.

6. The powered fastener driver of claim 5, wherein the linkage is inhibited from moving when the second trigger is in the first position due to the protrusion interfering with the second trigger via the recess.

7. The powered fastener driver of claim 6, wherein the protrusion is removed from the recess when the second trigger is in the second position.

8. The powered fastener driver of claim 7, wherein the linkage is moveable relative to the second trigger in unison with the first trigger when the second trigger is in the second position.

9. The powered fastener driver of claim 8, wherein the linkage is translatable in response to pivoting movement of the first trigger when a drive cycle is initiated.

10. The powered fastener driver of claim 3, further comprising:
a protrusion defined on one of the second end of the linkage or the trigger; and
a recess defined in the other of the second end of the linkage or the trigger,
wherein the protrusion is received in the recess when the second trigger is in the second position.

11. The powered fastener driver of claim 2, further comprising a spring biasing the linkage toward the first trigger.

12. The powered fastener driver of claim 11, wherein the linkage includes a first end adjacent the first trigger, and wherein the first end of the linkage is maintained in sliding contact with the first trigger by the spring.

13. The powered fastener driver of claim 12, wherein the linkage includes an opposite, second end adjacent the second trigger, and wherein the second end of the linkage is slideable relative to second trigger when the second trigger is in the second position.

14. The powered fastener driver of claim 2, further comprising a housing to which each of the first trigger and the second trigger is pivotably coupled.

15. The powered fastener driver of claim 14, wherein the linkage is positioned externally of the housing or internally to the housing.

16. The powered fastener driver of claim 1, further comprising a handle for a user to grasp when operating the fastener driver, wherein the first trigger is disposed on one side of the handle, and wherein the second trigger is disposed on an opposite side of the handle.

17. The powered fastener driver of claim 1, wherein the first trigger is configured to be actuated by the fingers of an operator's hand, and wherein the second trigger is configured to be actuated by the web of the same hand.

18. A method of operating a powered fastener driver, the method comprising:
providing a first trigger operable to initiate a drive cycle of a drive blade of the fastener driver;
actuating a second trigger from a first position to a second position; and
then, actuating the first trigger to initiate the drive cycle of the drive blade.

19. The method of claim 18, further comprising disengaging the second trigger from a linkage extending between the first and second triggers in response to actuation of the second trigger from the first position to the second position.

20. The method of claim 19, further comprising moving the linkage relative to the second trigger in unison with actuation of the first trigger.
